(19) United States
(12) Patent Application Publication
(10) Pub. No.: US 2018/0356938 A1
(43) Pub. Date: Dec. 13, 2018

(54) PROJECTION TOUCH SYSTEM AND CORRECTION METHOD THEREOF

(71) Applicant: Coretronic Corporation, Hsin-Chu (TW)

(72) Inventors: Cheng-Shen Lee, Hsin-Chu (TW); Chih-Neng Tseng, Hsin-Chu (TW)

(73) Assignee: Coretronic Corporation, Hsin-Chu (TW)

(21) Appl. No.: 16/003,127

(22) Filed: Jun. 8, 2018

(30) Foreign Application Priority Data
Jun. 13, 2017 (CN) 201710441982.1

(51) Int. Cl. G06F 3/041; G06F 3/044; G06F 3/045

(52) U.S. Cl. CPC G06F 3/0418; G06F 3/045; G06F 3/044

(57) ABSTRACT

A projection touch system including a processing device, a projection device, a touch film, and an image capturing device is provided. The processing device pre-stores a first coordinate transformation equation. The touch film is configured with a plurality of light sources. The image capturing device captures a first image frame on the touch film, where the first image frame includes images of the light sources. The processing device analyzes the first image frame to determine positions of the light sources in the first image frame, and establishes a second coordinate transformation equation. The processing device establishes a third coordinate transformation equation related to the touch film and the projection device according to the first coordinate transformation equation and the second coordinate transformation equation. Moreover, a correction method adapted to the projection touch system is also provided.

### CROSS-REFERENCE TO RELATED APPLICATION

This application claims the priority benefit of China application serial no. 201710441982.1, filed on Jun. 13, 2017. The entirety of the above-mentioned patent application is hereby incorporated by reference herein and made a part of this specification.

### BACKGROUND OF THE INVENTION

### Field of the Invention

The invention relates to a correction technique, and particularly relates to a projection touch system and a correction method thereof.

### Description of Related Art

Generally, when a projector projects an image frame on a projection surface, coordinates between the projector and the projection surface are required to be manually corrected such that a projection image may present a correct projection position on the projection surface. However, in the present technical field of the projector, more and more projectors are used for projecting projection images on the projection surface, where the projection surface is a non-planar surface. However, the conventional projector design needs to be manually adjusted by the user. Moreover, if the projection surface is further designed as a touch film having a touch function, the coordinate correction operation between the projector and the touch film requires a complicated correction procedure. For example, if the touch film is attached to a curved surface, the projector has to projector correction targets of more than a hundred points, and the user has to touch or click the correction targets one-by-one in a manual manner in order to simulate a real curvature of the curved surface. Therefore, how to accurately and effectively perform the coordinate correction operation on the projector and the touch film attached to the non-planar surface is one of the most important issues in the field.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY OF THE INVENTION

The invention is directed to a projection touch system and a correction method thereof, by which a projection and touch operation may be performed to a touch film attached to a plane or a non-planar surface, and a multi-point correction operation may be accurately and efficiently performed to improve a touch accuracy of the touch film.

In order to achieve one or a portion of or all of the objects or other objects, an embodiment of the invention provides a projection touch system. The projection touch system includes a processing device, a projection device, a touch film, and an image capturing device. The processing device is configured to pre-store a first coordinate transformation equation. The projection device is coupled to the processing device. The touch film is coupled to the processing device, and is configured with a plurality of light sources. The image capturing device is coupled to the processing device. The image capturing device is configured to capture a first image frame on the touch film, where the first image frame includes images of the light sources. The processing device analyzes the first image frame to determine positions of the light sources in the first image frame, and establishes a second coordinate transformation equation. The processing device establishes a third coordinate transformation equation related to the touch film and the projection device according to the first coordinate transformation equation and the second coordinate transformation equation.

In order to achieve one or a portion of or all of the objects or other objects, an embodiment of the invention provides a correction method adapted to a projection touch system. The projection touch system includes a touch film, a projection device and an image capturing device. The correction method includes: configuring a plurality of light sources on the touch film, and pre-storing a first coordinate transformation equation; capturing a first image frame of the touch film by the image capturing device, where the first image frame includes images of the light sources; analyzing the first image frame to determine positions of the light sources in the first image frame, and establishing a second coordinate transformation equation; and establishing a third coordinate transformation equation related to the touch film and the projection device according to the first coordinate transformation equation and the second coordinate transformation equation.

According to the above description, the embodiments of the invention have at least one of the following advantages and effects. The projection touch system and the correction method thereof of the invention may implement automatic correction operation between the projection device and the touch film. The projection touch system and the correction method thereof may establish the second coordinate transformation equation between the touch film and the image capturing device, and establish the third coordinate transformation equation according to the second coordinate transformation equation and the pre-stored first coordinate transformation equation, such that the projection touch system may adopt these coordinate transformation equations to perform accurate and efficient multi-point correction operation to the touch film.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a projection touch system according to an embodiment of the invention.

FIG. 2 is a schematic diagram of a projection touch system according to another embodiment of the invention.

FIG. 3 is a side view of the projection touch system of the embodiment of FIG. 1.

FIG. 4 is a schematic diagram of a correction image according to an embodiment of the invention.

FIG. 5 is a flowchart illustrating a correction method according to an embodiment of the invention.

### DESCRIPTION OF EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

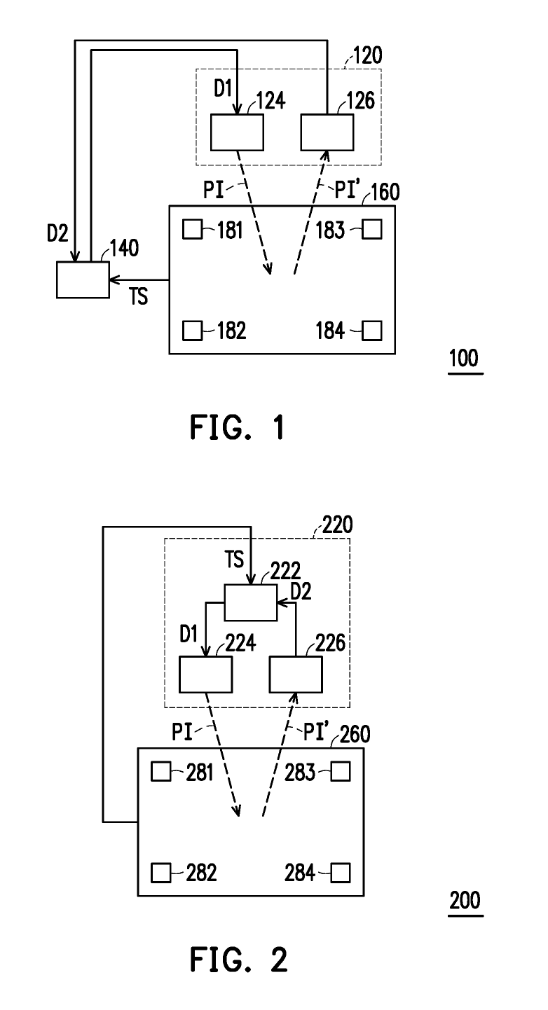

FIG. 1 is a schematic diagram of a projection touch system according to an embodiment of the invention. Referring to FIG. 1, in the present embodiment, the projection touch system 100 includes a projection system 120, a processing device 140 and a touch film 160. The touch film 160 is configured with a plurality of light sources 181, 182, 183, 184, and the light sources 181-184 may be configured in a region of the touch film 160 not having a touch function, though the invention is not limited thereto. The projection system 120 includes a projection device 124 and an image capturing device 126. In the present embodiment, the processing device 140 is disposed outside the projection system 120, and is coupled to the projection device 124 and the image capturing device 126, and the coupling method thereof is a wired or wireless way for transmitting information. In the present embodiment, the processing device 140 provides image data D1 to the projection device 124, and the projection device 124 projects an image frame PI on a projection surface of the touch film 160 according to the image data D1, where the image frame PI is formed by an image beam projected by the projection device 124. Moreover, the image capturing device 126 is configured to capture the image beam reflected by the image frame PI formed on the projection surface of the touch film 160, and the reflected image beam captured by the image capturing device 126 is defined as a captured image frame PI′. In the present embodiment, the image capturing device 126 may obtain image data D2 according to the captured image frame PI′, and transmit the image data D2 to the processing device 140.

In the present embodiment, the processing device 140 may be disposed outside the projection system 120. The processing device 140 is, for example, a central processing unit (CPU) having an image data processing function and a computation function, or other programmable general purpose or special purpose microprocessor, a digital signal processor (DSP), an image processing unit (IPU), a graphics processing unit (GPU), a programmable controller, an application specific integrated circuits (ASIC), a programmable logic device (PLD), other similar processing device or a combination of the above devices. Moreover, the processing device 140 may further include a storage device, where the storage device may be used for storing image processing programs, image data, data computation programs or coordinate transformation equations, etc. of the embodiments of the invention, and the processing device 140 may execute these programs, data and the coordinate transformation equations to implement the projection touch system and the correction method thereof described in the embodiments of the invention.

In another embodiment, the processing device 140 can also be configured in a desktop computer, a personal computer (PC), a portable terminal product, a personal digital assistor (PDA), a tablet PC, etc.

In the present embodiment, the image capturing device 126, for example, includes a charge coupled device (CCD) image sensor or a complementary metal oxide semiconductor (CMOS) image sensor, etc. Moreover, the projection device 124 may be a projector, and the projector has a light modulator, for example, a reflective or transmissive spatial light modulator. The reflective spatial light modulator is, for example, reflective liquid crystal on silicon (LCOS) or digital micro-mirror device (DMD), etc., and the transmissive spatial light modulator is, for example, a transparent liquid crystal panel. Moreover, based on different methods for inputting a control signal, the light modulator is, for example, an optically addressed spatial light modulator (OASLM) or an electrically addressed spatial light modulator (EASLM), and the patterns and types of the light modulator are not limited by the invention.

Referring to FIG. 1, in the present embodiment, the touch film 160 has a flexible feature, so that the touch film 160 may be attached on a planar or non-planar surface. The touch film 160 is, for example, a capacitive touch film applying a projected capacitive touch (PCT) technique or a resistive touch film, though the invention is not limited thereto. In an embodiment applying the capacitive touch film, the touch film 160 has a touch surface and a projection surface. The touch surface of the touch film 160 may be formed by a plurality of metal lines arranged in a grid form, and the touch surface of the touch film 160 may be used for sensing a touch result of a touch object 180 on the touch film 160 to generate a corresponding touch signal TS, and as the touch film 160 is coupled to the processing device 140, the touch signal TS is transmitted to the processing device 140. In the present embodiment, in case of a general touch operation, the projection device 124 projects an image beam to form the image frame PI on the projection surface of the touch film 160, and the user may view the image frame PI on the touch film 160, and meanwhile perform a touch operation according to the image frame projected on the touch film 160. The projection surface of the touch film 160 is a region of the image frame PI formed on the touch film 160, where the image frame PI is formed by the image beam projected by the projection device 124, and a range of such region is smaller than a range of the touch surface of the touch film 160.

Moreover, in the present embodiment, the touch object is, for example, a finger of the user or a capacitive touch pen.

In the present embodiment the light sources 181, 182, 183, 184 are, for example, respectively light-emitting diodes (LED), or infrared emitters, though the invention is not limited thereto. The light sources 181, 182, 183, 184 are used for emitting visible lights or invisible lights, which is not limited by the invention. It should be noted that the image capturing device is required to be configured to capture images of light spots produced by the light sources. Moreover, the light sources 181, 182, 183, 184 may be disposed at four corners of the touch film 160, though the number of the light sources and configuration positions thereof on the touch film 160 are not limited thereto, which can be determined according to an actual manufacturer design. In another embodiment, two light sources are configured at center positions of two side edges of the touch film 160. It should be noted that in the present embodiment, the processing device 140 may pre-store a first coordinate transformation equation related to the light sources 181, 182, 183, 184 and the touch film 160. Namely, during a manufacturing process of the projection touch system 100, relative positions between the light sources 181, 182, 183, 184 and the touch film 160 may be found in advance, so as to pre-establish the first coordinate transformation equation. For example, coordinates of fourth touch points close to the four corners in the touch film 160 are matched to coordinates of the light sources 181, 182, 183, 184, so as to establish the first coordinate transformation equation for storing in the processing device.

FIG. 2 is a schematic diagram of a projection touch system according to another embodiment of the invention. Referring to FIG. 2, in the present embodiment, the projection touch system 200 includes a projection system 220 and a touch film 260. The touch film 260 is configured with a plurality of light sources 281, 282, 283, 284. The projection system 220 includes a processing device 222, a projection device 224 and an image capturing device 226. In the present embodiment, the processing device 222 is configured in the projection system 220, and is adapted to receive image data provided by an external image source, and the processing device 222 is coupled to the projection device 224 and the image capturing device 226. In the present embodiment, the processing device 222 provides image data D1 to the projection device 224, and the projection device 224 projects the image frame PI on the projection surface of the touch film 260 according to the image data D1. Moreover, the image capturing device 226 is configured to capture the image frame formed on the touch film 260 to obtain the captured image frame PI′. In the present embodiment, the image capturing device 226 may obtain the image data D2 according to the captured image frame PI′, and transmit the image data D2 to the processing device 222.

Compared to the embodiment of FIG. 1, the processing device 222 of the present embodiment is configured in the projection system 220. Namely, the projection system 220 of the present embodiment has the image data processing function and computation function, and is used as a projector. The projection system 220 may receive the touch signal TS generated by a touch object by performing a touch operation on the touch film 260. Meanwhile, the projection device 224 of the projection system 220 projects the image frame PI, and the image capturing device 226 of the projection system 220 captures the captured image frame PI′. Moreover, the projection system 220 may further include a storage device, where the storage device may be used for storing an image processing module, a data computation module or image data, etc., and the processing device 220 may execute these modules and data to implement the projection touch system and the correction method thereof described in the embodiments of the invention. However, enough instructions and recommendations for other device features of the present embodiment may be learned from the embodiment of FIG. 1, and details thereof are not repeated.

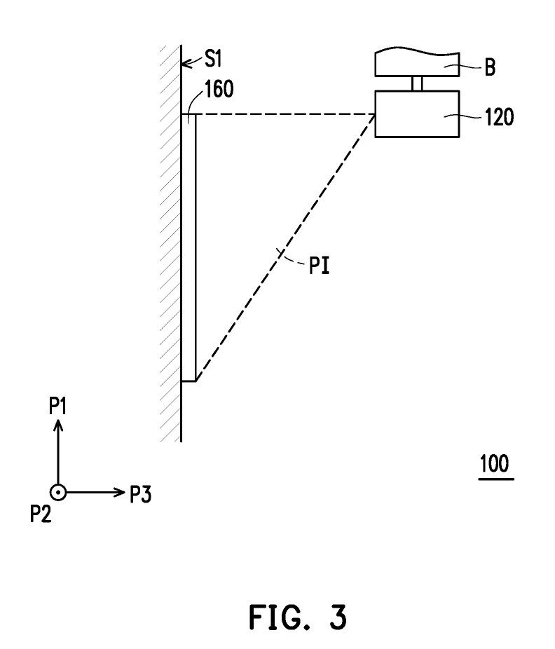

FIG. 3 is a side view of the projection touch system of the embodiment of FIG. 1. Referring to FIG. 1 and FIG. 3, in the present embodiment, the projection system 120 can be installed on a fixed object B, such that the projection device 124 may project the image frame PI to the touch film 160 in a fixed angle. The touch film 160 can be attached on a surface S1, where the surface S1 may be extended on a plane formed by a first direction P1 and a second direction P2. In the present embodiment, the fixed object B may be extended on a plane formed by the second direction P2 and a third direction P3, and the fixed object B is, for example, a ceiling or a support member, etc., which is not limited by the invention. In other embodiments, the projection system 120 can be disposed on a desktop, etc. The first direction P1, the second direction P2 and the third direction P3 are perpendicular to each other.

In the present embodiment, if the touch film 160 is attached on the non-planar surface S1, for example, the surface S1 is a curved surface, which is a regular curved surface or an irregular curved surface, where a radius of curvature of the curved surface is adopted to define whether the curved surface is the regular curved surface or the irregular curved surface, the image projected by the projection device 124 of the projection system 120 on the touch film 160 may have an image shift or image distortion phenomenon. Moreover, a result that the user performs the touch operation on the touch film 160 based on the image frame PI projected on the touch film 160 is also shifted, which causes an inconvenience and error result in usage of the projection touch system 100. Therefore, the projection touch system 100 of the present embodiment establishes coordinate transformation equations among the projection device 124, the image capturing device 126 and the touch film 160 to resolve the above problem. To be specific, a purpose of the correction is that when the user uses the projection touch system 100, even if the touch film 160 is attached on the non-planar surface, regarding the image data provided to the projection device 124 by the processing device 140, the image data (for example, coordinate positions of image) of the projection device 124 may correspond to the coordinate positions of the touch film 160.

In case that the correction method of the invention is applied, when the touch film 160 is attached to the non-planar surface S1, the image capturing device 126 captures the image frame PI′ on the touch film 160, where the image frame PI′ further includes the images of the light sources 181, 182, 183, 184, and through the image capturing device 126, the processing device 140 records the image frame PI′ to serve as a first image frame, where the first image frame includes the images of the light sources 181, 182, 183, 184. The processing device 140 analyzes the first image frame to determine coordinate information of the light sources 181, 182, 183, 184 in the first image frame. A second coordinate transformation equation is established according to the coordinate information of the light sources 181, 182, 183, 184 in the first image frame and the first coordinate transformation equation, where the second coordinate transformation equation is related to coordinate transformation between the touch film 160 and the image capturing device 126. The processing procedure of the above analysis includes obtaining coordinate information of a substantial center position of the light sources in the first image frame, or includes omitting broken regions when the first image frame is interfered or has the broken regions, so as to accelerate the image processing.

It should be noted that taking the coordinate transformation between the image capturing device 126 and the light sources 181, 182, 183, 184 set on the touch film 160 as an example, in the present embodiment, the coordinates of the light sources 181, 182, 183, 184 on the touch film 160 are, for example, respectively (0,0), (1,0), (1,1) and (0,1). In other embodiments, the number of the light sources is not limited by the invention. In the present embodiment, the image capturing device 126 captures the image frame PI′ of the touch film 160, and the processing device 140 analyzes the image frame PI′ to obtain the coordinate information of the light sources 181, 182, 183, 184 set on the touch film 160 in the image frame PI′. However, since the touch film 160 may be attached on the non-planar surface S1, the coordinates of the light sources 181, 182, 183, 184 in the image frame PI′ are probably shifted. Therefore, the coordinates of the light sources 181, 182, 183, 184 in the image frame P1′ are, for example, respectively (X₀,Y₀), (X₁,Y₁), (X₂,Y₂) and (X₃,Y₃), i.e. the touch signal TS, and the touch film 160 provides the touch signal TS to the processing device 140. In this way, the processing device 140 may establish following equations (1)-(5) according to the image frame PI′ in the processing device 140 and the coordinates information of the light sources 181, 182, 183, 184 on the touch film 160:

$$\begin{matrix}M = [ \begin{matrix}a & d & 0 & g \\ b & e & 0 & h \\ 0 & 0 & 1 & 0 \\ c & f & 0 & 1\end{matrix} ] & equation ( 1 ) \\ [ \begin{matrix}{X}_{0} & {Y}_{0} & 0 & 1\end{matrix} ] = [ \begin{matrix}0 & 0 & 0 & 1\end{matrix} ] \times M & equation ( 2 ) \\ [ \begin{matrix}{X}_{1} & {Y}_{1} & 0 & 1\end{matrix} ] = [ \begin{matrix}1 & 0 & 0 & 1\end{matrix} ] \times M & equation ( 3 ) \\ [ \begin{matrix}{X}_{2} & {Y}_{2} & 0 & 1\end{matrix} ] = [ \begin{matrix}1 & 1 & 0 & 1\end{matrix} ] \times M & equation ( 4 ) \\ [ \begin{matrix}{X}_{3} & {Y}_{3} & 0 & 1\end{matrix} ] = [ \begin{matrix}0 & 1 & 0 & 1\end{matrix} ] \times M & equation ( 5 )\end{matrix}$$

In the above equations (1)-(5), the symbol M represents a homogeneous transformation matrix, the symbols a-h are parameters. According to the above equations (1)-(5), it is known that the transformation matrix M may translate the coordinates (0,0), (1,0), (1,1) and (0,1) into coordinates (X₀,Y₀), (X₁,Y₁), (X₂,Y₂) and (X₃,Y₃), and it is assumed that a length and a width of the projection region of the touch film 160 are all 1. In this embodiment, the processing device 140 may calculate the above equations (1)-(5) to obtain inversed transformation matrices. The inversed transformation matrices and the transformation equations may be following equations (6)-(10):

$$\begin{matrix}{M}^{- 1} = [ \begin{matrix}A & D & 0 & G \\ B & E & 0 & H \\ 0 & 0 & 1 & 0 \\ C & F & 0 & I\end{matrix} ] & equation ( 6 ) \\ [ \begin{matrix}{X}_{0} & {Y}_{0} & 0 & 1\end{matrix} ] \times {M}^{- 1} = [ \begin{matrix}0 & 0 & 0 & 1\end{matrix} ] & equation ( 7 ) \\ [ \begin{matrix}{X}_{1} & {Y}_{1} & 0 & 1\end{matrix} ] \times {M}^{- 1} = [ \begin{matrix}1 & 0 & 0 & 1\end{matrix} ] & equation ( 8 ) \\ [ \begin{matrix}{X}_{2} & {Y}_{2} & 0 & 1\end{matrix} ] \times {M}^{- 1} = [ \begin{matrix}1 & 1 & 0 & 1\end{matrix} ] & equation ( 9 ) \\ [ \begin{matrix}{X}_{3} & {Y}_{3} & 0 & 1\end{matrix} ] \times {M}^{- 1} = [ \begin{matrix}0 & 1 & 0 & 1\end{matrix} ] & equation ( 10 )\end{matrix}$$

In the above equations (6)-(10), the symbol M⁻¹ represents an inversed transformation matrix, the symbols A-I are parameters. The processing device 140 may calculate the parameters a-h of the equations (1)-(5) to obtain the corresponding parameters A-I. Namely, the processing device 140 may obtain the coordinates (X₀,Y₀), (X₁,Y₁), (X₂,Y₂) and (X₃,Y₃) of the light sources 181, 182, 183, 184 in the image frame PI′ according to the inversed transformation matrix M⁻¹. To be specific, the processing device 140 may obtain the parameters A-I through operation of the parameters a-h according to the above equations (1)-(10), so as to establish a coordinate transformation equation, which is shown as a following equation (11):

[X Y 0 1]×M⁻¹=[x y 0 1] equation (11)

In the above equation (11), the symbol x and the symbol y represent corrected coordinates. Namely, a coordinate transformation may be performed to the coordinates (X,Y) of each point in the image frame PI′ through the above equation (11), so as to correct the coordinates (X,Y) of each point in the image frame PI′ into correct coordinates (x,y).

However, in another embodiment, it is assumed that the length and the width of the projection region of the touch film 160 are all r, the processing device 140 may further multiply the above inversed transformation matrix M⁻¹ by a four order matrix with a proportional constant of r. The inversed transformation matrix and the transformation equations are shown as following equations (12)-(16):

$$\begin{matrix}MA = {M}^{- 1} \times [ \begin{matrix}r & 0 & 0 & 0 \\ 0 & r & 0 & 0 \\ 0 & 0 & 1 & 0 \\ 0 & 0 & 0 & 1\end{matrix} ] = [ \begin{matrix}A & D & 0 & G \\ B & E & 0 & H \\ 0 & 0 & 1 & 0 \\ C & F & 0 & I\end{matrix} ] \times [ \begin{matrix}r & 0 & 0 & 0 \\ 0 & r & 0 & 0 \\ 0 & 0 & 1 & 0 \\ 0 & 0 & 0 & 1\end{matrix} ] & equation ( 12 ) \\ [ \begin{matrix}{X}_{0} & {Y}_{0} & 0 & 1\end{matrix} ] \times MA = [ \begin{matrix}0 & 0 & 0 & 1\end{matrix} ] & equation ( 13 ) \\ [ \begin{matrix}{X}_{1} & {Y}_{1} & 0 & 1\end{matrix} ] \times MA = [ \begin{matrix}1 & 0 & 0 & 1\end{matrix} ] & equation ( 14 ) \\ [ \begin{matrix}{X}_{2} & {Y}_{2} & 0 & 1\end{matrix} ] \times MA = [ \begin{matrix}1 & 1 & 0 & 1\end{matrix} ] & equation ( 15 ) \\ [ \begin{matrix}{X}_{3} & {Y}_{3} & 0 & 1\end{matrix} ] \times MA = [ \begin{matrix}0 & 1 & 0 & 1\end{matrix} ] & equation ( 16 )\end{matrix}$$

In the above equations (12)-(16), the symbol MA represents another inversed transformation matrix, and the another inversed transformation matrix MA is obtained by multiplying the inversed transformation matrix M⁻¹ by a four order matrix with a proportional constant of r. Therefore, the processing device 140 may correct the coordinates (X₀,Y₀), (X₁,Y₁), (X₂,Y₂) and (X₃,Y₃) of the light sources 181, 182, 183, 184 in the image frame PI′ according to the inversed transformation matrix MA, and meanwhile correct proportions of distances between light sources 181, 182, 183, 184 in the image frame PI′. To be specific, the processing device 140 may obtain the parameters A-I through computation of the parameters a-h according to the above equations (1)-(16), so as to establish another coordinate transformation equation, which is shown as a following equation (17):

[X Y 0 1]×MA=[x y 0 1] equation (17)

In the above equation (17), the symbol x and the symbol y represent the corrected coordinates. Namely, coordinate transformation may be performed to the coordinates (X,Y) of each point in the image frame PI′ through the above equation (17), so as to correct the coordinates (X,Y) of each point in the image frame PI′ into correct coordinates (x,y), and meanwhile correct proportions of the distances between the coordinates (X,Y) of each point in the image frame PI′.

It should be noted that the number of the light sources set on the touch film 160 is not limited by the invention, and the coordinate transformation equation between the light sources set on the touch film and the touch film, and the coordinate transformation equation between the touch film and the image capturing device may all be implemented with reference of the operation method of the aforementioned established equations (1)-(17). However, enough instructions and recommendations for the matrix operation method and parameter operation method between the aforementioned transformation matrices and the inversed transformation matrices may be learned from ordinary knowledge of the field, and details thereof are not repeated. Moreover, to fully convey the spirit of the correction method and the projection touch system of the invention to those skilled in the art, an exemplary embodiment is provided below for further description.

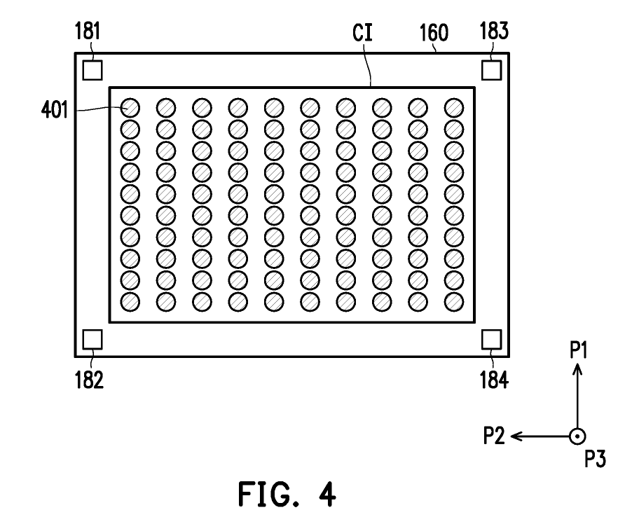

FIG. 4 is a schematic diagram of a correction image according to an embodiment of the invention. Referring to FIG. 1, FIG. 3, FIG. 4, first, in the present embodiment, the light sources 181, 182, 183, 184 are configured on the touch film 160, and the processing device 140 pre-stores the coordinate information of the light sources 181, 182, 183, 184. In the present embodiment, the processing device 140 pre-stores the first coordinate transformation equation, where the first coordinate transformation equation is related to coordinate transformation between the light sources 181, 182, 183, 184 set on the touch film 160 and the touch film 160.

Then, in the present embodiment, the image capturing device 126 captures the image frame PI′ of the touch film 160, and the processing device 140 records the image frame PI′ to serve as the first image frame. The processing device 140 analyzes the first image frame to determine the coordinate information of the light sources 181, 182, 183, 184 in the first image frame, and establishes the second coordinate transformation equation according to the first coordinate transformation equation and the coordinate information of the light sources 181, 182, 183, 184 in the first image frame. In the present embodiment, the second coordinate transformation equation is related to coordinate transformation between the touch film 160 and the image capturing device 126, where the processing procedure of the above analysis includes obtaining coordinate information of a substantial center position of the light sources in the first image frame, or includes omitting broken regions when the first image frame is interfered or has the broken regions, so as to accelerate the image processing.

In the present embodiment, the processing device 140 may deduce a third coordinate transformation equation according to the first coordinate transformation equation and the second coordinate transformation equation. To be specific, since the first coordinate transformation equation is related to coordinate transformation between the light sources 181, 182, 183, 184 set on the touch film 160 and the touch film 160, and the second coordinate transformation equation is related to coordinate transformation between the touch film 160 and the image capturing device 126, in the present embodiment, the third coordinate transformation equation is related to coordinate transformation between the touch film 160 and the projection device 124.

In the present embodiment, the projection device 124 projects the image frame PI to the touch film 160, where the image frame PI may present a correction image CI as shown in FIG. 4. The correction image CI may include figures of 100 correction targets 401, though the number of the correction targets is not limited thereto. In the present embodiment, the touch film 160 is attached on a non-planar surface, so that the correction targets 401 of the correction image CI may be distributed in regions of a plurality of planes on the touch film 160. In the present embodiment, the processing device 140 may capture the correction image CI projected to the touch film 160 by the projection device 124 by using the image capturing device 126, so as to obtain the captured image frame PI′. The processing device 140 may record the captured image frame PI′ to serve as the second image frame. In the present embodiment, the processing device 140 may analyze the second image frame to obtain coordinate information of the correction targets 401, where the processing procedure of the above analysis includes obtaining coordinate information of a substantial center position of the light sources in the first image frame, or includes omitting broken regions when the first image frame is interfered or has the broken regions, so as to accelerate the image processing.

In the present embodiment, the processing device 140 adopts the second coordinate transformation equation to obtain relative coordinate relationships of the correction targets 401 corresponding to the touch film 160. Namely, the processing device 140 of the present embodiment may sequentially establish the second coordinate transformation equation and the third coordinate transformation equation, and the processing device 140 adopts the second coordinate transformation equation to execute multi-point correction operation to the projection touch system 100. In other words, since the touch film 160 is probably attached on the non-planar surface S1, the processing device 140 may correspondingly correct the touch region of the touch film 160 according to a size variation of the image frame projected by the projection device 124, so as to improve touch accuracy of the touch film 160.

It should be noted that the first coordinate transformation equation, the second coordinate transformation equation and the third coordinate transformation equation may be similar to the aforementioned equation (11) or equation (17). Namely, the processing device 140 of the present embodiment may execute an operation method similar to that of the aforementioned equations (1)-(17) to generate the first coordinate transformation equation, the second coordinate transformation equation and the third coordinate transformation equation of the present embodiment, and detail thereof is not repeated.

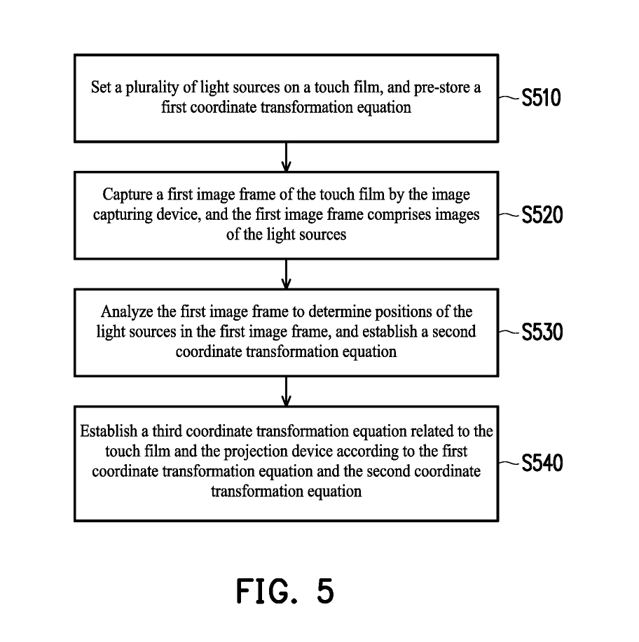

FIG. 5 is a flowchart illustrating a correction method according to an embodiment of the invention. Referring to FIG. 5, the correction method of the present embodiment is at least adapted to the projection touch systems 100 of FIG. 1. In step S510, the projection touch system 100 configures a plurality of the light sources 181, 182, 183, 184 on the touch film 160, and pre-stores the first coordinate transformation equation. In step S520, the projection touch system 100 captures a first image frame of the touch film 160 by using the image capturing device 126, where the first image frame includes images of the light sources 181, 182, 183, 184. In step S530, the projection touch system 100 analyzes the first image frame to determine positions of the light sources 181, 182, 183, 184 in the first image frame, and establishes a second coordinate transformation equation according to the first coordinate transformation equation. In step S540, the projection touch system 100 establishes a third coordinate transformation equation related to the touch film 160 and the projection device 124 according to the first coordinate transformation equation and the second coordinate transformation equation. Therefore, the projection touch system 100 of the present embodiment may adopt the first coordinate transformation equation, the second coordinate transformation equation and the third coordinate transformation equation to perform the multi-point correction operation to the touch film 160.

In summary, the embodiments of the invention have at least one of the following advantages and effects. The touch film of the invention may be attached on a planar or non-planar surface. The projection touch system and the correction method of the invention may configure a plurality of light sources on the touch film, and pre-set the first coordinate transformation equation related to coordinate transformation between the light sources and the touch film. The projection touch system and the correction method of the invention may further establish the second coordinate transformation equation related to coordinate transformation between the touch film and the image capturing device and the third coordinate transformation equation related to coordinate transformation between the projection device and the touch film, such that the projection touch system may adopt these coordinate transformation equations to perform accurate and efficient multi-point correction operation to the touch film, to as to improve the touch accuracy of the touch film.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection touch system, comprising:
a processing device, configured to pre-store a first coordinate transformation equation;
a projection device, coupled to the processing device;
a touch film, coupled to the processing device, and configured with a plurality of light sources;
an image capturing device, coupled to the processing device, and configured to capture a first image frame on the touch film, wherein the first image frame comprises images of the light sources, the processing device analyzes the first image frame to determine positions of the light sources in the first image frame, and establishes a second coordinate transformation equation,
wherein the processing device establishes a third coordinate transformation equation related to the touch film and the projection device according to the first coordinate transformation equation and the second coordinate transformation equation.

2. The projection touch system as claimed in claim 1, wherein the touch film is attached to a non-planar surface.

3. The projection touch system as claimed in claim 1, wherein the projection device is configured to project a correction image to the touch film, and the correction image comprises a plurality of correction targets, wherein the processing device performs to capture the correction image projected to the touch film by the image capturing device, so as to generate a second image frame,
wherein the processing device analyzes the second image frame to obtain coordinate information of the correction targets, and adopts the second coordinate transformation equation to obtain relative coordinate relationship of the correction targets corresponding to the touch film.

4. The projection touch system as claimed in claim 3, wherein the touch film is attached to a non-planar surface, and the correction targets of the correction image are distributed in regions of a plurality of different planes of the touch film.

5. The projection touch system as claimed in claim 1, wherein the light sources comprise four light sources respectively disposed at four corners of the touch film.

6. The projection touch system as claimed in claim 1, wherein the light sources respectively emit a visible light or an invisible light.

7. The projection touch system as claimed in claim 1, wherein the processing device pre-stores coordinate information between the touch film and the light sources, and determines the first coordinate transformation equation.

8. The projection touch system as claimed in claim 1, wherein the touch film is a capacitive touch film or a resistive touch film.

9. A correction method, adapted to a projection touch system, wherein the projection touch system comprises a touch film, a projection device and an image capturing device, and the touch film has a plurality of light sources, the correction method comprising:
pre-storing a first coordinate transformation equation;
capturing a first image frame of the touch film by the image capturing device, wherein the first image frame comprises images of the light sources;
analyzing the first image frame to determine positions of the light sources in the first image frame, and establishing a second coordinate transformation equation; and
establishing a third coordinate transformation equation related to the touch film and the projection device according to the first coordinate transformation equation and the second coordinate transformation equation.

10. The correction method as claimed in claim 9, wherein the touch film is attached to a non-planar surface.

11. The correction method as claimed in claim 9, further comprising:
projecting a correction image to the touch film by the projection device, wherein the correction image comprises a plurality of correction targets;
capturing the correction image projected to the touch film by the image capturing device, so as to generate a second image frame; and
analyzing the second image frame to obtain coordinate information of the correction targets, and adopting the second coordinate transformation equation to obtain relative coordinate relationship of the correction targets corresponding to the touch film.

12. The correction method as claimed in claim 11, wherein the touch film is attached to a non-planar surface, and the correction targets of the correction image are distributed in regions of a plurality of different planes of the touch film.

13. The correction method as claimed in claim 9, wherein the step of configured the light sources on the touch film comprises:
respectively disposing four light sources at four corners of the touch film.

14. The correction method as claimed in claim 9, wherein the light sources respectively emit a visible light or an invisible light.

15. The correction method as claimed in claim 9, wherein the step of pre-storing the first coordinate transformation equation comprises:
pre-storing coordinate information between the touch film and the light sources, and determining the first coordinate transformation equation.

16. The correction method as claimed in claim 9, wherein the touch film is a capacitive touch film or a resistive touch film.
